(19) United States
(12) Patent Application Publication
(10) Pub. No.: US 2006/0182947 A1
(43) Pub. Date: Aug. 17, 2006

(54) Fiber reinforced thermoplastic composite including mineral fillers

(75) Inventors: Huda A. Jerri, Lynchburg, VA (US); Peter L. Wallace, Cornwall (GB); Daniel Scott Woodman, Lynchburg, VA (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(73) Assignee: Azdel, Inc.

(21) Appl. No.: 11/058,776

(22) Filed: Feb. 16, 2005

(51) Int. Cl. B32B 5/22; B32B 3/26; B32B 3/00; D04H 1/00; B32B 5/18; B32B 5/16; D04H 3/00

(52) U.S. Cl. 428/316.6; 442/77; 442/417; 428/304.4

(57) ABSTRACT

A composite sheet material includes, in an exemplary embodiment, a permeable core that includes a plurality of reinforcing fibers bonded together with a thermoplastic resin, and about 0.01 weight percent to about 20 weight percent of a mineral filler. The permeable core includes a surface region.

### BACKGROUND OF THE INVENTION

This invention relates generally to porous fiber reinforced thermoplastic polymer sheets, and more particularly to porous fiber reinforced thermoplastic polymer sheets that include mineral fillers.

Porous fiber reinforced thermoplastic sheets have been described in U.S. Pat. Nos. 4,978,489 and 4,670,331 and are used in numerous and varied applications in the product manufacturing industry because of the ease of molding the fiber reinforced thermoplastic sheets into articles. Known techniques, for example, thermo-stamping, compression molding, and thermoforming have been used to successfully form articles from fiber reinforced thermoplastic sheets.

In some industries, for example, the automotive industry, there is a need for products formed from porous fiber reinforced thermoplastic sheets that have a lower weight per unit area than known products. One way to accomplish this is to reduce the thickness of the porous fiber reinforced thermoplastic sheet. However, a reduction in thickness usually also produces a reduction in strength and stiffness of the product. Another way to accomplish a weight reduction is to reduce the weight per unit area of the product while maintaining the same thickness. However, in order to accomplish this, the amount of material, for example, reinforcing fibers, is reduced, and the void percentage is increased in the product. Accordingly, the physical properties of the product are also reduced. In addition, because less material is used for a given thickness, there is less material to absorb sound, and the acoustic properties of the product are also reduced.

### BRIEF DESCRIPTION OF THE INVENTION

In one aspect, a composite sheet material is provided. The composite sheet material includes a permeable core that includes a plurality of reinforcing fibers bonded together with a thermoplastic resin, and about 0.01 weight percent to about 20 weight percent of a mineral filler. The permeable core includes a surface region.

In another aspect, a method of manufacturing a porous, fiber reinforced thermoplastic sheet that includes about 0.01 to about 20 weight percent of a mineral filler is provided. The method includes adding reinforcing fibers, thermoplastic resin particles and mineral filler particles to an agitated aqueous foam to form a dispersed mixture, laying the dispersed mixture of reinforcing fibers, thermoplastic particles and mineral filler particles down onto a forming element, evacuating the water to form a web, heating the web above the softening temperature of the thermoplastic resin, and pressing the web to a predetermined thickness to form a porous thermoplastic sheet having a void content of about 1 percent to about 95 percent.

### BRIEF DESCRIPTION OF THE DRAWINGS

FIG. 1 is sectional illustration of a composite plastic sheet in accordance with an embodiment of the present invention.

### DETAILED DESCRIPTION OF THE INVENTION

A porous, fiber reinforced thermoplastic sheet that includes, in one exemplary embodiment, about 0.01 weight percent to about 20 weight percent of a mineral filler is described below in detail. The thermoplastic sheet has a weight per unit area that is lower than known fiber reinforced thermoplastic sheets. The thermoplastic sheet with mineral fillers manufactured at a weight of about 600 grams per square meter (g/m²) to about 700 g/m² exhibits strength and stiffness properties, and acoustic properties that are equivalent to thermoplastic sheets without mineral fillers that have a weight greater than 700 g/m^{2.}

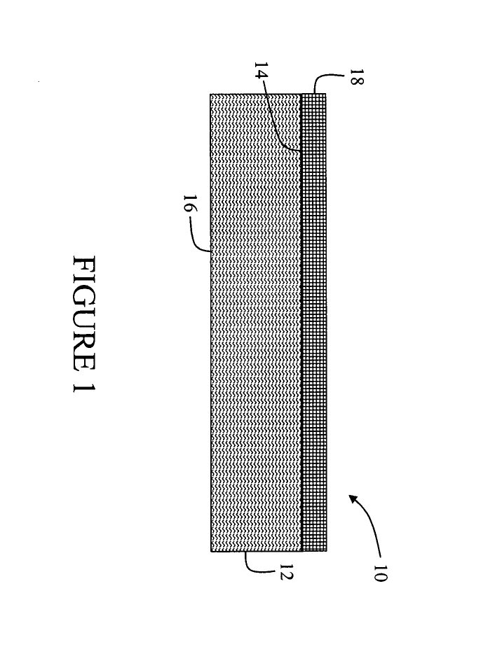

Referring to the drawing, FIG. 1 is a cross sectional schematic illustration of an exemplary composite thermoplastic sheet 10 that includes a porous core 12 having a first surface 14 and a second surface 16. A binder layer 18 is applied to first surface 14. In alternate embodiments, a binder layer is applied to second surface 16.

Core 12 is formed from a web made up of open cell structures formed by random crossing over of reinforcing fibers held together, at least in part, by one or more thermoplastic resins, where the void content of porous core 12 ranges in general between about 1% and about 95% and in particular between about 30% and about 80% of the total volume of core 12. In another embodiment, porous core 12 is made up of open cell structures formed by random crossing over of reinforcing fibers held together, at least in part, by one or more thermoplastic resins, where about 40% to about 100% of the cell structure are open and allow the flow of air and gases through. Core 12 also includes mineral filler particles to reduce the weight per unit area of core 12 at a given thickness. Core 12 is formed using known manufacturing process, for example, a wet laid process, an air laid process, a dry blend process, a carding and needle process, and other known process that are employed for making non-woven products. Combinations of such manufacturing processes are also useful.

Core 12 includes about 20% to about 80% by weight of reinforcing fibers having an average length of between about 5 mm and about 50 mm, and about 20% to about 80% by weight of a wholly or substantially unconsolidated fibrous or particulate thermoplastic materials, where the weight percentages are based on the total weight of core 12. In another embodiment, core 12 includes about 30% to about 55% by weight of reinforcing fibers. Core 12 includes reinforcing fibers having an average length of between about 5 mm and about 25 mm. Suitable reinforcing fibers include, but are not limited to metal fibers, metalized inorganic fibers, metalized synthetic fibers, glass fibers, graphite fibers, carbon fibers, ceramic fibers, basalt fibers, inorganic fibers, aramid fibers, and mixtures thereof.

Core 12, in the exemplary embodiment, includes about 0.01 weight percent to about 20 weight percent of a mineral filler. In another embodiment, core 12 includes about 0.1 weight percent to about 15 weight percent of a mineral filler, and in another embodiment from about 1.0 weight percent to about 10 weight percent of a mineral filer. The mineral filler includes at least one of acicular particles, plate-like particles, and block-like particles. Suitable, non-limiting, examples of mineral fillers include barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, silica, silicon dioxide, titanium dioxide, and mixtures thereof.

In the exemplary embodiment, reinforcing fibers having an average length of about 5 mm to about 50 mm are added with mineral filler particles and thermoplastic powder particles, for example polypropylene powder, to an agitated aqueous foam which can contain a surfactant. The components are agitated for a sufficient time to form a dispersed mixture of the reinforcing fibers, mineral filler particles, and thermoplastic powder/granules in the aqueous foam. The dispersed mixture is then laid down on any suitable porous forming support structure, for example, a wire mesh and then the water is evacuated through the support structure forming a web. The web is dried and heated above the softening temperature of the thermoplastic powder. The web is then cooled and pressed to a predetermined thickness to produce a composite sheet having a void content of between about 1 percent to about 95 percent.

The web is heated above the softening temperature of the thermoplastic resins on core 12 to substantially soften the plastic materials and is passed through one or more consolidation devices, for example calendaring rolls, double belt laminators, indexing presses, multiple daylight presses, autoclaves, and other such devices used for lamination and consolidation of sheets and fabrics so that the plastic material can flow and wet out the fibers. The gap between the consolidating elements in the consolidation devices are set to a dimension less than that of the unconsolidated web and greater than that of the web if it were to be fully consolidated, thus allowing the web to expand and remain substantially permeable after passing through the consolidating elements. In one embodiment, the gap is set to a dimension about 5% to about 10% greater than that of the web if it were to be fully consolidated. A fully consolidated web means a web that is fully compressed and substantially void free. A fully consolidated web would have less than 5% void content and have negligible open cell structure.

In one embodiment, the mineral filler particles are pre-blended with the thermoplastic particles before adding the blended particles to the agitated aqueous foam. A low melting point wax and/or an antioxidant can be used to aid the blending of the materials. In another embodiment, the mineral filler particles are incorporated into the thermoplastic particles. For example, the mineral filler particles are ground into the thermoplastic while it is in a molten state. The thermoplastic is then solidified and ground to the desired particle size.

Particulate plastic materials can include short plastics fibers which can be included to enhance the cohesion of the web structure during manufacture. Bonding is affected by utilizing the thermal characteristics of the plastic materials within the web structure. The web structure is heated sufficiently to cause the thermoplastic component to fuse at its surfaces to adjacent particles and fibers.

In one embodiment, individual reinforcing fibers should not on the average be shorter than about 5 millimeters, because shorter fibers do not generally provide adequate reinforcement in the ultimate molded article. Also, fibers should not on average be longer than about 50 millimeters since such fibers are difficult to handle in the manufacturing process.

In one embodiment, in order to confer structural strength, the reinforcing fibers have an average diameter between about 7 and about 22 microns. Fibers of diameter less than about 7 microns can easily become airborne and can cause environmental health and safety issues. Fibers of diameter greater than about 22 microns are difficult to handle in manufacturing processes and do not efficiently reinforce the plastics matrix after molding.

In one embodiment, the thermoplastics material is, at least in part, in a particulate form. Suitable thermoplastics include, but are not limited to, polyolefins, including polymethylene, polyethylene, and polypropylene, polystyrene, acrylonitrylstyrene, butadiene, polyesters, including polyethyleneterephthalate, polybutyleneterephthalate, and polypropyleneterephthalate, polybutyleneterachlorate, and polyvinyl chloride, both plasticized and unplasticized, acrylics, including polymethyl methacrylate, and blends of these materials with each other or other polymeric materials. Other suitable thermoplastics include, but are not limited to, polyarylene ethers, acrylonitrile-butylacrylate-styrene polymers, amorphous nylon, as well as alloys and blends of these materials with each other or other polymeric materials. It is anticipated that any thermoplastics resin can be used which is not chemically attacked by water and which can be sufficiently softened by heat to permit fusing and/or molding without being chemically or thermally decomposed.

The thermoplastic particles need not be excessively fine, but particles coarser than about 1.5 millimeters are unsatisfactory in that they do not flow sufficiently during the molding process to produce a homogenous structure. The use of larger particles can result in a reduction in the flexural modulus of the material when consolidated.

Binder layer 18 is formed from a thermoplastic material, and in one embodiment, includes from 0.01 weight percent to about 20 weight percent of a mineral filler. In another embodiment, binder layer 18 does not include a mineral filler. The thermoplastic material of binder layer 18 can be any suitable resin that adheres well to core layer 12. Binder 18 is formulated to be compatible with all materials in core 12, as binder constituents significantly improve the adhesion and coupling between organic resins and inorganic surfaces. Binder 18 reacts with many types of resins, and promotes bonding to many inorganic materials such as fillers and fibers. Binder may be applied as a liquid, which then forms a film on surface 14 of core 12 to maintain the integrity of core 12 throughout the heating and consolidation phases. Binder 18 is also suctioned through core, and provides improved material performance. The adhesion of binder 18 should be substantially unchanged during the life of thermoplastic sheet 10 after it is subjected to processing conditions that include heat, humidity, and thermal cycling. Suitable thermoplastic resins include, but are not limited to, polyolefinic resins such as polyethylene, polypropylene and the like; polystyrene, polyvinyl chloride, polyethylene terephthalate, polycarbonate, polyamide, polyacetal and copolymers formed from these resins, and grafted products thereof; thermoplastic elastomers such as EPM, EPDM and the like; as well as polymer alloys and blends of these materials with each other or other polymeric materials. Binder layer 18 can be applied to core 12 by any suitable method, for example, coating at least one surface of core 12 by spraying, curtain coating, or the like.

In one embodiment, the total amount of mineral filler in composite thermoplastic sheet 10 is present in core 12. In another embodiment, the total amount of mineral filler in composite thermoplastic sheet 10 is present in binder layer 18, and in still another embodiment, the mineral filler is present in both core 12 and binder layer 12.

In alternate embodiments, decorative skins and/or barrier layers are bonded to binder layer 18. In further alternate embodiments, decorative skins and/or barrier layers are bonded directly to first surface 14 and/or second surface 16 of core 12.

While the invention has been described in terms of various specific embodiments, those skilled in the art will recognize that the invention can be practiced with modification within the spirit and scope of the claims.

What is claimed is:

1. A composite sheet material comprising:
a permeable core comprising a plurality of reinforcing fibers bonded together with a thermoplastic resin, said permeable core including a surface region; and
about 0.01 weight percent to about 20 weight percent of a mineral filler.

2. A composite sheet material in accordance with claim 1 wherein said mineral filler comprises at least one of acicular particles, plate-like particles, block-like particles.

3. A composite sheet material in accordance with claim 1 wherein said permeable core has an open cell structure with a void content of about 1 percent to about 95 percent of the total volume of said permeable core.

4. A composite sheet material in accordance with claim 1 wherein said permeable core comprises a thermoplastic resin selected from the group consisting of polyolefins, polystyrene, acrylonitrylstyrene, butadiene, polyesters, polybutyleneterachlorate, polyvinyl chloride, polyphenylene ether, polycarbonates, polyestercarbonates, acrylonitrile-butylacrylate-styrene polymers, amorphous nylon, and mixtures thereof.

5. A composite sheet material in accordance with claim 1 wherein said thermoplastic resin comprises about 0.01 weight percent to about 20 weight percent of a mineral filler.

6. A composite sheet material in accordance with claim 1 further comprising a binder layer applied to at least a portion of said surface region, said binder layer comprising about 0.01 weight percent to about 20 weight percent of a mineral filler.

7. A composite sheet material in accordance with claim 1 comprising about 0.1 weight percent to about 15 weight percent of a mineral filler.

8. A composite sheet material in accordance with claim 1 wherein said mineral filler is incorporated into said permeable core.

9. A composite sheet material in accordance with claim 1 wherein said mineral filler comprises at least one of barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, silica, silicon dioxide, and titanium dioxide.

10. A composite sheet material in accordance with claim 1 wherein said thermoplastic resin comprises about 0.1 weight percent to about 15 weight percent of a mineral filler.

11. A method of manufacturing a porous, fiber reinforced thermoplastic sheet comprising about 0.01 to about 20 weight percent of a mineral filler, said method comprising:
adding reinforcing fibers, thermoplastic resin particles and mineral filler particles to an agitated aqueous foam to form a dispersed mixture;
laying the dispersed mixture of reinforcing fibers, thermoplastic particles and mineral filler particles down onto a forming support element;
evacuating the water to form a web;
heating the web above the softening temperature of the thermoplastic resin; and
pressing the web to a predetermined thickness to form a porous thermoplastic sheet having a void content of about 1 percent to about 95 percent.

12. A method in accordance with claim 11 wherein adding reinforcing fibers, thermoplastic resin particles and mineral filler particles to an agitated aqueous foam comprises:
incorporating the mineral filler particles in the thermoplastic resin particles; and
adding the reinforcing fibers and the thermoplastic resin particles with the incorporated mineral filler particles to the agitated aqueous foam to form the dispersed mixture.

13. A method in accordance with claim 11 wherein adding reinforcing fibers, thermoplastic resin particles and mineral filler particles to an agitated aqueous foam comprises:
blending the thermoplastic resin particles and the mineral filler particles to form a mixture of thermoplastic resin and mineral filler particles; and
adding the reinforcing fibers and mixture of thermoplastic resin and mineral filler particles to the agitated aqueous foam to form the dispersed mixture.

14. A method in accordance with claim 13 wherein blending the thermoplastic resin particles and the mineral filler particles comprises blending the thermoplastic resin particles and the mineral filler particles in the presence of at least one of an antioxidant and a wax.

15. A method in accordance with claim 11 wherein the mineral filler comprises at least one of acicular particles, plate-like particles, block-like particles.

16. A method in accordance with claim 11 wherein the porous, fiber reinforced thermoplastic sheet has an open cell structure with a void content of about 1 percent to about 95 percent of the total volume of said permeable core.

17. A method in accordance with claim 11 wherein the thermoplastic resin comprises at least one of polyolefins, polystyrene, acrylonitrylstyrene, butadiene, polyesters, polybutyleneterachlorate, polyvinyl chloride, polyphenylene ether, polycarbonates, polyestercarbonates, acrylonitrile-butylacrylate-styrene polymers, and amorphous nylon.

18. A method in accordance with claim 11 wherein the porous, fiber reinforced thermoplastic sheet comprises about 0.1 weight percent to about 15 weight percent of a mineral filler.

19. A method in accordance with claim 11 wherein the mineral filler comprises at least one of barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, silica, silicon dioxide, and titanium dioxide.

20. A method in accordance with claim 11 further comprising coating at least one surface of the fiber reinforced thermoplastic sheet with a binder, the binder comprising about 0.01 to about 20 weight percent of a mineral filler
